(19) United States
(12) Patent Application Publication
(10) Pub. No.: US 2011/0226408 A1
(43) Pub. Date: Sep. 22, 2011

(54) METHOD AND MACHINE FOR THE PRODUCTION OF A MATERIAL STRIP COMPRISING MICROSTRUCTURES

(75) Inventors: Rainer Melzer, Schwelm (DE); Roland Melzer, Schwelm (DE)

(73) Assignee: Melzer Maschinenbau GmbH, Schwelm (DE)

(21) Appl. No.: 12/998,658

(22) PCT Filed: Nov. 18, 2009
(86) PCT No.: PCT/DE2009/001659

§ 371 Date: May 16, 2011

(30) Foreign Application Priority Data
Dec. 11, 2008 (DE) 10 2008 061 879.9

(51) Int. Cl. B29C 70/00; B29C 65/00; B29C 59/02

(52) U.S. Cl. 156/209; 156/535

(57) ABSTRACT

A method for producing a material strip (1) comprising microstructures, particularly a laminated material strip having at least two layers and comprising security-relevant features (18), in that at least one material strip formed by two strips (1′, 1″) running parallel to each other in an aligned manner is guided through a machine containing at least heating (8, 9), pressing (12, 13) and cooling means (10, 11), wherein transport means (2, 3) for the material strip are equipped with elements (19) that have a profile comprising the respective microstructures, and the profile is reproduced on the material strip over the course of the heating and pressing operations.

The invention relates to a method for the production of a material strip comprising microstructures, particularly of an at least two-ply laminated material strip comprising security-relevant features.

DE 199 50 474 A1 relates to a device for section-by-section lamination of a layered structure composed of at least two plastic strips having consecutively configured panels, for the production of plastic cards, along a conveying distance comprising consecutively disposed heating and cooling devices, which are formed by pressing organs that can be individually tempered and accommodate a whole number of panels, which organs are disposed on a common carrier and have a fixed lower as well as a movable upper pressing bar, in each instance, and pressing belt runs that can be intermittently driven in a conveying direction and face one another, by means of which runs the plastic strips disposed between them can be moved through the heating and cooling devices section by section.

DE 10 2006 001 700 A1 shows a method for the production of a document having a numbering, particularly of a laminated card or the like, whereby the numbering is applied to a printed sheet in multiple panels, and the document is subsequently laminated. Printed sheets can be provided with a plurality of individual documents. When numberings are applied in a machine comprising heating, pressing, and cooling means, it can happen that the sheet, in each instance, stretches at first, and subsequently shrinks again. Thus, unnecessary scrap is produced in that the numberings to be applied by means of the heating and cooling phases are not always applied at the same location of the documents to be produced.

The invention is based on the task of making available a method for the production of a material strip comprising microstructures, into or onto which strip the microstructures, particularly the security-relevant features, can be introduced or applied, respectively, in simple form, with precise fit.

Furthermore, a machine for the production of material strips comprising microstructures is supposed to be made available, which machine is simple in structure and with which the microstructures, in each instance, can be introduced or applied into the material strips, with precise fit, so that the microstructures are always provided at the same location in the case of documents to be produced later.

This task is accomplished by means of a method for the production of a material strip comprising microstructures, particularly of an at least two-ply laminated material strip comprising security-relevant features, in that a material strip formed from at least two strips that run parallel to one another, in aligned form, is passed through a machine that comprises at least heating, pressing, and cooling means, whereby transport means for the material strip are fitted with elements that have a profile comprising the microstructures, in each instance, and this profile is reproduced on the material strip during the course of the heating and pressing process.

Advantageous further developments of the object of the invention can be derived from the dependent object claims.

This task is also accomplished by a machine for the production of a material strip comprising microstructures, particularly of an at least two-ply laminated material strip comprising security-relevant features, having at least one heating, pressing, and cooling means, at least one transport means for a material strip formed from at least two strips that run parallel to one another, in aligned form, whereby the transport means is provided for accommodating elements configured in segment-type manner and having profiles, to produce the microstructure, in each instance.

Advantageous further developments of the machine according to the invention can be derived from the related dependent object claims.

The microstructures, particularly the security-relevant features, can be formed not only by means of elevations but also by means of depressions having the most varied contours, which are provided in/on the segment(s).

Using the method according to the invention, or the machine according to the invention, respectively, it is now possible to produce material strips comprising microstructures, particularly at least two-ply laminated material strips provided with security-relevant features, for the production of documents or the like. The material strips, which preferably consist of plastic, such as polycarbonate or polyester, for example, can be endowed with a plurality of, if necessary of different, layers (strips), depending on the case of use. Depending on the application case, the security-relevant feature(s) is/are reproduced on at least one of the layers. The microstructures introduced into the layer, in each instance, by means of temperature and pressure, are particularly embossed into it, whereby raised or indented regions are produced in the layer, in each instance.

Fully automated operation can be implemented by means of devices that precede and follow the machine, in such a manner that at least two individual strips are combined to produce a material composite (material strip), which is passed through the heating, pressing, and cooling means of the machine, using the transport means, whereby here, the microstructures are introduced or applied into or onto the strip surface. A subsequent device can function as an intermediate buffer, for example, while another device undertakes separation of the documents comprising the microstructures.

Documents in the sense of the object of the invention are, for example, ID cards, bank and credit cards, identification documents such as personal identity cards, passports, drivers' licenses, or the like.

The microstructure, in each instance, or the security-relevant features, can be an MLI (Multiple Laser Image) structure or a CLI (Changeable Laser Image) structure, which is introduced into the segment, in each instance, as a negative profile. The following are also viewed as being microstructures: engravings, microprints, guilloches, printing for the blind, such as Braille, as well as latent images or the like.

The individual segments can be connected with one another in the form of an intermittently circulating transport belt (reproduction belt), for example by means of welding.

Here, however, there is the problem that when individual segments are worn away, problems can occur in replacing the worn segment, since first of all, the fixed connection between individual systems must be released.

Alternatively, it is proposed that the transport means, which can be formed by means of circulating transport chains, for example, accommodates the segments. Same can be releasably connected with the transport means, for example by means of a screw connection, pin connection, cotter pin connection, or the like. If one or another segment becomes worn, it can be replaced in simple manner, by loosening the connection and replacing the segment.

The object of the invention is represented on the basis of an exemplary embodiment, and will be explained as follows. The figures show:

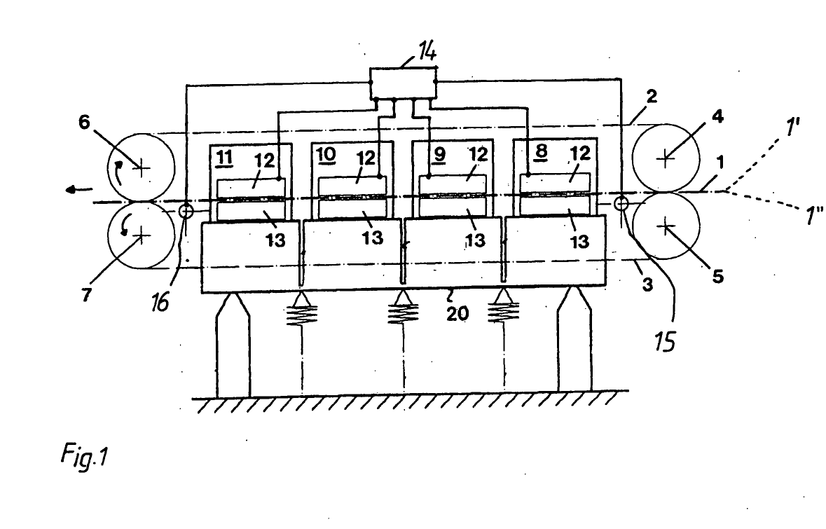

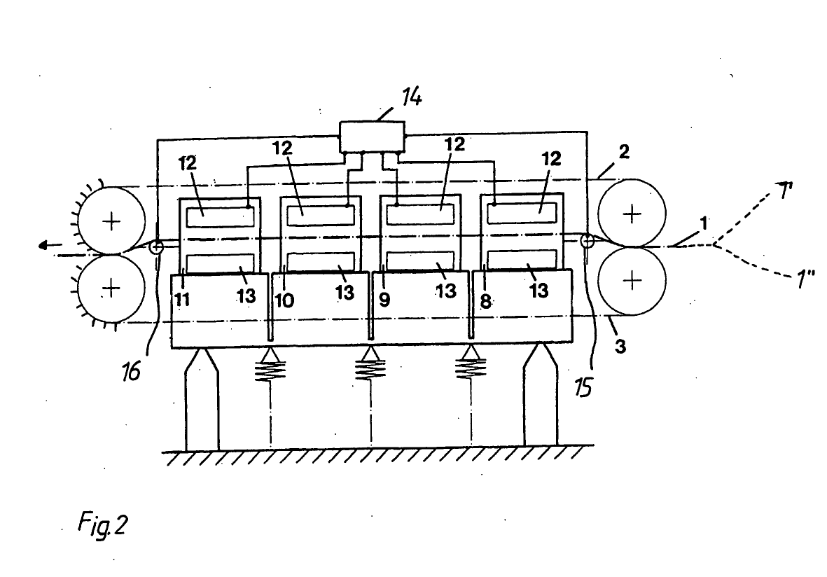

FIGS. 1 and 2 side views of a machine according to the invention, on the one hand with closed pressing means, and on the other hand with open pressing means;

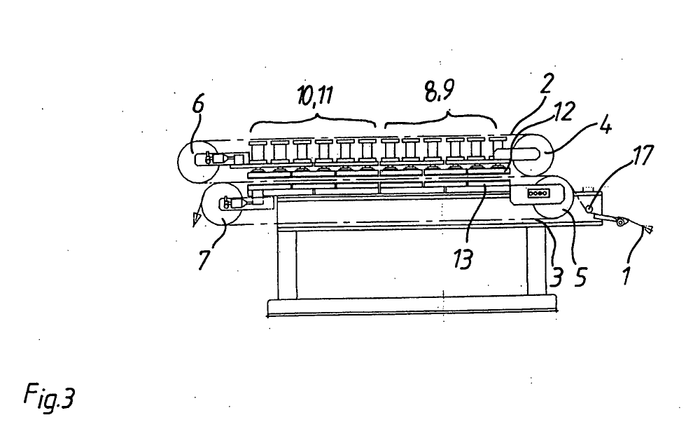

FIG. 3 schematic diagrams of an alternative machine according to the invention;

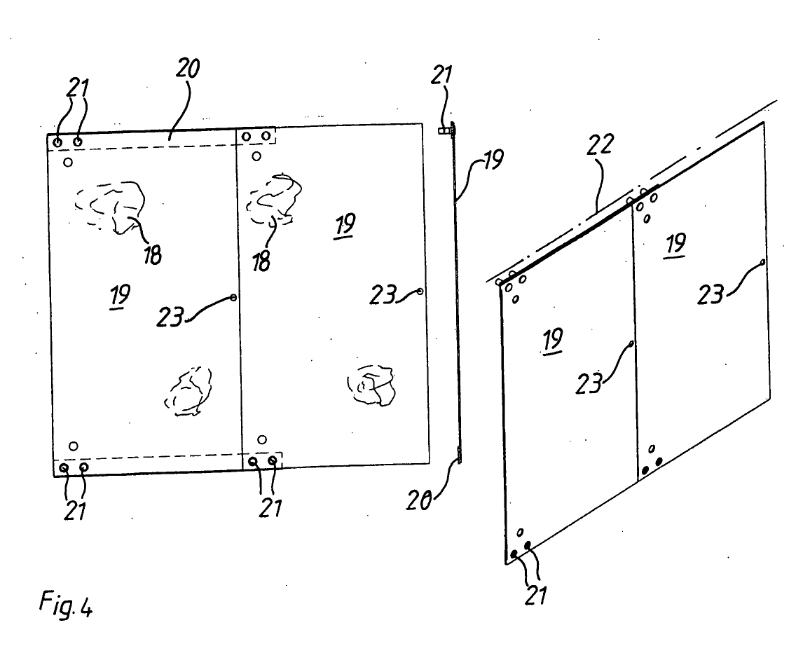

FIG. 4 schematic diagrams of segments comprising microstructures, which segments are releasably connected with one another.

FIGS. 1 and 2 show a machine according to the invention, for example for section-by-section lamination of a material strip 1, which is formed, in this example, by means of two plastic strips 1′, 1″, as a partial station of a system for the production of documents, along a conveying segment. The plastic strips 1′, 1″, which are also defined as panels, are passed to roll-off devices (not shown) that precede the machine, and transported in the direction of the arrow. The plastic strips 1′, 1″ that form the material strip 1 are passed in synchronously, whereby the different plastic strips 1′, 1″ to be laminated to produce the material strip 1 can have passed through different processing stations previously. After the at least two plastic strips 1′, 1″ have been combined, they form the material strip 1. The material strip 1 runs into a gap between two pressing belt runs 2, 3, which are formed by two closed transport belts that face one another, which belts are laid over a run-in drum 4, 5 and a run-out drum 6, 7, in each instance. At least one of the transport belts, but preferably both of them, is/are driven incrementally, and take the material strip 1 with them during the circulating movement.

As will be described later, entrainment elements for the material strip 1 are provided in the region of the pressing belt runs 2, 3, which elements guarantee slip-free transport of the strip through the machine. Consecutive heating means 8, 9 and cooling means 10, 11 are disposed along the pressing belt runs 2, 3, which means are formed by individual pressing organs that can be tempered. The number of heating means 8, 9 and cooling means 10, 11 disposed one behind the other can be selected. The heating means 8, 9 and the cooling means 10, 11 are disposed at a distance from one another, in each instance, and are configured with an upper pressing bar 12 and a lower pressing bar 13, in each instance. The material strip 1 passes through the machine according to the invention between the upper pressing bar 12 and the lower pressing bar 13, guided between the two pressing belt runs 2, 3, in the direction of the arrow.

FIG. 1 shows the two pressing bars 12, 13, in each instance, in a closed position of the pressing organs for tempered pressure treatment of the material strip 1, whereby at least the upper pressing bar 13 can be moved in the manner of a punch, in order to exert a pressure force on the lower pressing bar 13. As will be explained in greater detail in the following figures, the pressing belt runs 2, 3 are provided with segments that consist of sheet metal, which have a profile formed by a microstructure, which is reproduced on defined sections of the material strip 1 during the course of the tempered pressure treatment. After the tempered pressure treatment has been finished, the pressing organs are opened by raising the upper pressing bar 12, in each instance, and the pressing belts 2, 3 with the material strip 1 treated in certain sections are moved further, in the direction of the arrow. For example, the section of the material strip 1 treated in the heating means 8, 9 is moved into the region of the cooling means 10, 11. A controller 14 is provided for activation of the pressing bars 12, 13, the heating means 8, 9, and the cooling means 10, 11, respectively.

FIG. 2 shows the machine according to the invention, according to FIG. 1, with the upper pressing bar 12 open. The individual pressing organs are individually adjustable in terms of their temperature and the pressure exerted by them, whereby the material strip 1 provided with the microstructure, in each instance, forms a stable laminate material. The presses are opened, in each instance, for incremental advancing of the material strip 1. The duration of the heating and cooling processes determines the cycle times. Furthermore, lifting devices 15, 16 are provided in the input region and output region of the machine, which devices can be moved upward with a vertical component, with reference to the pressing belt runs 2, 3, as can be seen in FIG. 2.

FIG. 3, as a schematic diagram, shows another machine according to the invention, which is also equipped with heating 8 and cooling means 9, in analogy to FIGS. 1 and 2. Also present are upper pressing bars 12 and lower pressing bars 13. The pressing belt runs 2, 3, which are formed by segments configured in sheet-metal manner, are disposed offset relative to one another in this schematic diagram. In a preceding device, not shown in greater detail, the individual strips 1′, 1″ indicated in FIGS. 1 and 2 were combined to produce the material strip 1. The material strip 1 is passed into the gap between the run-in drums 4, 5 by way of the deflection roller 17, and runs through the conveying distance (arrow direction) in this manner, as described in FIGS. 1 and 2. The material strip 1 is passed to its further destination, particularly to a separation device, in the region of the run-out drums 6, 7. Similarly as described in FIGS. 1 and 2, here, too, a microstructure is introduced at a location of the material strip 1 that can be predetermined, in the region of the heating means 8, 9, in combination with the upper and lower pressing bars 12, 13.

FIG. 4, as a schematic diagram, shows two segments 19 comprising microstructures 18, which segments are connected with one another, and, in this example, releasably stand in an active connection with one another by way of a connection rail 20. The segments 19 are releasably connected with one another by way of pin-like connection elements 21. Depending on the application case, the connection rail 20 can be formed by a tab chain 22, which is merely indicated. Further recesses 23 that serve to accommodate pin-like entrainment elements, with which corresponding register holes of the material strip to be transported are brought into an active connection, are merely indicated. As a result of these entrainment elements, slip-free transport of the material composite is guaranteed. The microstructures 18 are thus always applied onto or into the material strip at the same locations, for example embossed on or in. After documents have been produced by means of separation, such as punching or the like, all the documents produced in this manner always have the introduced or applied microstructure at the same location, so that significant advantages can be achieved for further processing of the material composite.

### Reference Symbol List

1 material strip
1′ plastic strip
1″ plastic strip
2 pressing belt run
3 pressing belt run
4 run-in drum
5 run-in drum
6 run-out drum
7 run-out drum
8 heating means
9 heating means
10 cooling means
11 cooling means
12 pressing bar
13 pressing bar
14 controller
15 lifting device
16 lifting device
17 deflection roller
18 microstructure
19 segment
20 connection rail
21 connection element
22 tab chain
23 recess

1. Method for the production of a material strip (1) comprising microstructures (18), particularly of an at least two-ply laminated material strip (1) comprising security-relevant features (18), in that at least one material strip (1) formed from at least two strips (1′, 1″) that run parallel to one another, in aligned form, is passed through a machine that comprises at least heating (8, 9), pressing (12, 13), and cooling means (10, 11), whereby transport means (2, 3) for the material strip (1) are fitted with elements that have a profile comprising the microstructures (18), in each instance, and this profile (18) is reproduced on the material strip (1) during the course of the heating and pressing process.

2. Method according to claim 1, wherein the material strip (1) that consists of plastic is intermittently passed through the heating (8, 9), pressing (12, 13), and cooling means (10, 11) of the machine.

3. Method according to claim 1, wherein the transport means for the material strip (1) are fitted with elements (19) configured in segment-type manner, comprising the profile, in each instance.

4. Method according to claim 1, wherein the segments (19) for formation of a circulating reproduction and transport belt (2, 3) are connected with one another in fixed manner, particularly by means of welding.

5. Method according to claim 1, wherein the segments (19) are releasably connected with the transport means, in each instance, particularly transport chains.

6. Method according to claim 1, wherein the material strip (1) is equipped with a transponder.

7. Method according to claim 1, wherein an MLI microstructure or a CLI microstructure is introduced into or applied to the material strip (1).

8. Method according to claim 1, wherein the material strip (1) is separated into documents comprising the microstructures (18), particularly the security-relevant features, indirectly or directly after leaving the machine.

9. Machine for the production of a material strip (1) comprising microstructures (18), particularly of an at least two-ply laminated material strip (1) comprising security-relevant features (18), having at least one heating (8, 9), pressing (12, 13), and cooling means (10, 11), at least one transport means (2, 3) for a material strip (1) formed from at least two strips that run parallel to one another, in aligned form, whereby the transport means (2, 3) is provided for accommodating elements (19) configured in segment-type manner and having profiles, to produce the microstructure (18), in each instance.

10. Machine according to claim 9, wherein the segments (19), formed by sheet-metal parts, are connected with one another in fixed manner, particularly by means of welding.

11. Machine according to claim 9, wherein the segments (19), formed by sheet-metal parts, are releasably and interchangeably connected with the transport means, which are particularly formed by means of transport chains.

12. Machine according to claim 9, wherein the transport means (2, 3) intermittently passes the material strip (1) through the heating (8, 9), pressing (12, 13), and cooling means (10, 11).

13. Machine according to claim 9, wherein the transport means (2, 3), in each instance, is formed by two belt runs that can be driven intermittently and in opposite directions, with which the material strip (1) can be moved, whereby at least one of the runs (2, 3) is equipped with the segments (19) that comprise the profiles (18), in each instance.

14. Machine according to claim 9, wherein entrainment elements for a material strip having a corresponding counter-profile are provided in the region of the transport means (2, 3) or the segments (19).

15. Machine according to claim 9, wherein the entrainment elements are formed by pins that engage into corresponding recesses of the material strip (1), so that the material strip (1) is provided with microstructures (18), particularly security-relevant features (18), that are uniformly spaced apart.
